(19) United States
(12) Patent Application Publication
(10) Pub. No.: US 2026/0319824 A1
(43) Pub. Date: Oct. 15, 2026

(54) INFORMATION PROCESSING APPARATUS, DATA STORAGE METHOD, AND COMPUTER READABLE RECORDING MEDIUM

(71) Applicant: Fsas Technologies Inc., Kawasaki-shi (JP)

(72) Inventors: Tomohiro ISHIYAMA, Kawasaki (JP); Masakazu SAKAMOTO, Kawasaki (JP); Toshikazu UCHIYAMA, Kawasaki (JP); Shigeki SEKINE, Kawasaki (JP); Shunya MIMURO, Kawasaki (JP); Osamu NAGASHIMA, Kawasaki (JP)

(73) Assignee: Fsas Technologies Inc., Kawasaki-shi (JP)

(21) Appl. No.: 19/633,457

(22) Filed: Mar. 30, 2026

(30) Foreign Application Priority Data
Apr. 9, 2025 (JP) 2025-064501

(51) Int. Cl. G06F 9/455

(52) U.S. Cl. CPC G06F 9/45558; G06F 2009/45583; G06F 2009/45591

(57) ABSTRACT

An information processing apparatus includes a processor configured to acquire data on an amount of resource usage of a virtual machine at intervals of a first time period, the amount of resource usage being measured periodically for the first time period, based on the data acquired, calculate a first average obtained by averaging the amount of resource usage for the first time period and a second average obtained by averaging the amount of resource usage at intervals of a second time period obtained by dividing the first time period into a plurality of segments, and extract an amount of usage of higher-level resource for the first time period as higher-level data and extract an amount of usage of lower-level resource for the first time period as lower-level data from the data acquired.

### CROSS-REFERENCE TO RELATED APPLICATION

This application is based upon and claims the benefit of priority of the prior Japanese Patent Application No. 2025-064501, filed on Apr. 9, 2025, the entire contents of which are incorporated herein by reference.

### FIELD

The embodiment discussed herein is related to an information processing apparatus, a data storage method, and a data storage program.

### BACKGROUND

The amount of resource usage has been measured periodically, and, based on data on the measured amount of resource usage, the amount of usage of a resource to be used in the future has been estimated. For example, in a related technology, traffic observation information is collected from nodes in a network, traffic is estimated based on the collected traffic observation information, and an appropriate route is calculated. The related technologies are described, for example, in: Japanese Laid-open Patent Publication No. 2017-41821.

### SUMMARY

According to an aspect of the embodiments, an information processing apparatus includes a processor configured to: acquire data on an amount of resource usage of a virtual machine at intervals of a first time period, the amount of resource usage being measured periodically for the first time period; based on the data acquired, calculate a first average obtained by averaging the amount of resource usage for the first time period and a second average obtained by averaging the amount of resource usage at intervals of a second time period obtained by dividing the first time period into a plurality of segments; extract an amount of usage of higher-level resource for the first time period as higher-level data and extract an amount of usage of lower-level resource for the first time period as lower-level data from the data acquired; by using the first average and a plurality of the second averages calculated and the higher-level data and the lower-level data extracted as parameters, perform compressed sensing for the data acquired to generate pattern information; and exert control over storage of the pattern information generated in a storage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system according to an embodiment;

FIG. 2 is a block diagram illustrating a configuration example of a management server according to the embodiment;

FIG. 3 is a diagram to explain an example of extraction of higher-level data and lower-level data according to the embodiment;

FIG. 4 is a diagram to explain an example of matching determination of the higher-level data and the lower-level data according to the embodiment;

FIG. 5 is a diagram to explain an example of a data structure according to a comparative example;

FIG. 6 is a diagram to explain an example of the number of possible patterns of CPU usage rate as higher-level data and lower-level data according to the embodiment;

FIG. 7 is a diagram to explain an example of a data structure according to the embodiment;

FIG. 8 is a diagram to explain an example of estimation results according to the embodiment;

FIG. 9 is a flowchart illustrating a processing procedure of data storage processing according to the embodiment; and

FIG. 10 is a diagram illustrating an example of the hardware configuration of a computer that realizes the same functions as those of the management server according to the embodiment.

### DESCRIPTION OF EMBODIMENTS

To enhance the estimation accuracy of the amount of resource usage, the measurement interval of the amount of resource usage needs to be shorter. However, when the measurement interval is shorter, the amount of resource usage to be measured is larger, which causes an increase in storage area for storing the measured amount of resource usage.

In one aspect, an object of the present invention is to provide an information processing apparatus, a data storage method, and a data storage program that are capable of storing the measured amount of resource usage in a smaller storage area.

Preferred embodiments will be explained with reference to accompanying drawings. Hereinafter, an embodiment of an information processing apparatus, a data storage method, and a data storage program disclosed in the present application is described in detail with reference to the drawings. Note that the present invention shall not be limited by the embodiment.

### Embodiment

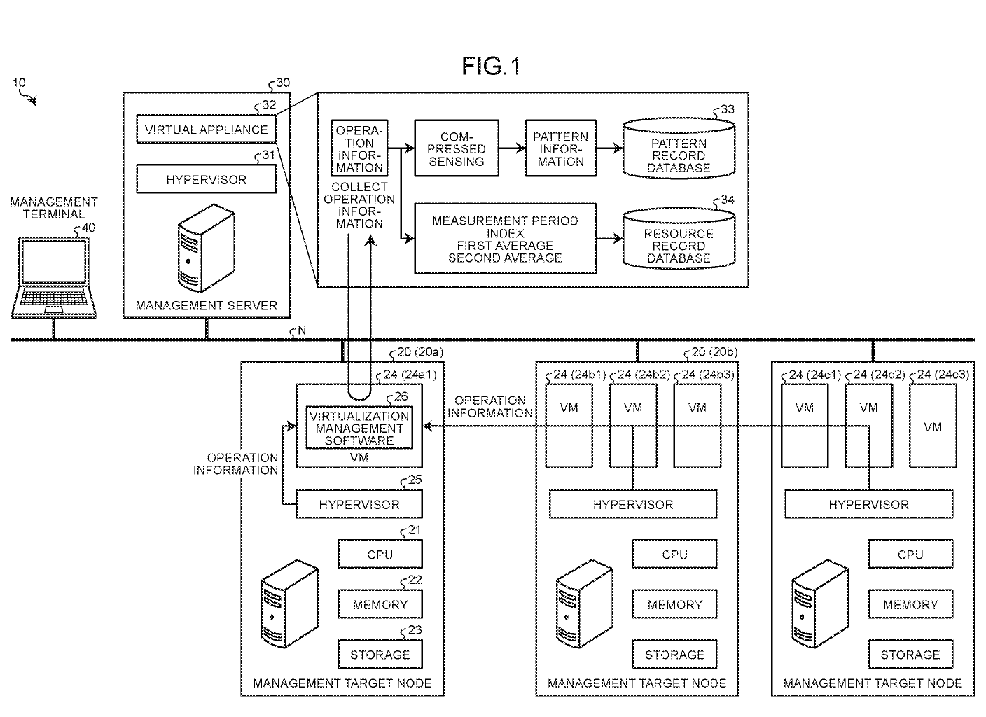

FIG. 1 is a diagram illustrating an example of a system 10 according to the embodiment. The system 10 is a system configured to virtualize, manage, and operate physical machines such as server computers and hardware such as storage and switches. The system 10 includes a plurality of management target nodes 20, a management server 30, and a management terminal 40. The management target nodes 20, the management server 30, and the management terminal 40 are communicatively connected via a network N.

The management target nodes 20 are physical machines such as server computers. The management target nodes 20 each include a central processing unit (CPU) 21, memory 22, and storage 23. In the management target nodes 20, virtual machines (VM) 24 are operated by virtualization technology. For example, in each of the management target nodes 20, a hypervisor 25 operates, and the virtual machines 24 operate on the hypervisor 25. For example, in a management target node 20a, a virtual machine 24a1 operates. In a management target node 20b, virtual machines 24b1 to 24b3 operate. In a management target node 20c, virtual machines 24c1 to 24c3 operate. In the virtual machine 24a1 in the management target node 20a, virtualization management software 26 operates.

The hypervisor 25 in each of the management target nodes 20 manages a virtual environment in which the virtual machine 24 operates. The hypervisor 25 manages resources, that is, the CPU 21, the memory 22, the storage 23, and other devices in the management target node 20, and allocates the resources to the virtual machines 24 operating on the hypervisor 25.

The management server 30 is an information processing apparatus such as a server computer. In the management server 30, a hypervisor 31 operates, and a virtual appliance 32 operates on the hypervisor 31. The virtual appliance 32 manages the virtual machines 24 via the hypervisors 25 of the management target nodes 20.

The management terminal 40 is a terminal device operated by an administrator of the system 10 and is an information processing apparatus such as a personal computer. The administrator operates the management terminal 40 to access the management server 30 and operates the virtual appliance 32 to manage the virtual machines 24.

In the system 10, a higher load on a particular virtual machine 24 or another reason sometimes causes an imbalance in loads on the management target nodes 20. In that case, the system 10 fails in effectively utilizing the resources in the management target nodes 20.

Therefore, the system 10 periodically measures the amount of resource usage in each of the virtual machines 24, and, based on data on the measured amount of resource usage, the system 10 estimates the amount of usage of resources to be used in the future by each of the virtual machines 24, and reallocates the virtual machines 24 so as to achieve balanced loads on the management target nodes 20.

For example, the hypervisor 25 in each of the management target nodes 20 periodically measures, at predetermined time intervals, the amount of resource usage in each of the virtual machines 24 operating on the hypervisor 25. The hypervisor 25 transmits the periodically measured amount of resource usage in each of the virtual machines 24 and operation information including a measurement period of the amount of resource usage to the virtualization management software 26 of the virtual machine 24a1 at intervals of a first time period. The measurement period includes the measurement start date and time and the measurement end date and time for the measurement of the amount of resource usage. The virtualization management software 26 transmits the operation information on each of the virtual machines 24 to the management server 30, the operation information having been received from each of the hypervisors 25.

The management server 30 receives the operation information on each of the virtual machines 24 from the virtualization management software 26 at intervals of the first time period.

To enhance the estimation accuracy of the amount of resource usage, the measurement interval of the amount of resource usage needs to be shorter. However, when the measurement interval is shorter, the amount of resource usage to be measured is larger, which causes an increase in storage area for storing the measured amount of resource usage.

Therefore, the virtual appliance 32 of the management server 30 performs compressed sensing for the amount of resource usage included in the received operation information in each of the virtual machines 24, whereby pattern information is generated. The virtual appliance 32 associates the generated pattern information with a unique identifier and stores the pattern information in a pattern record database 33. For example, the virtual appliance 32 associates the generated pattern information with an index as the identifier and stores the pattern information in the pattern record database 33. Furthermore, for each of the virtual machines 24, the virtual appliance 32 stores, in the resource record database 34, the measurement period, the index associated with the pattern information, and first and second averages used to generate the pattern information, each being included in the operation information.

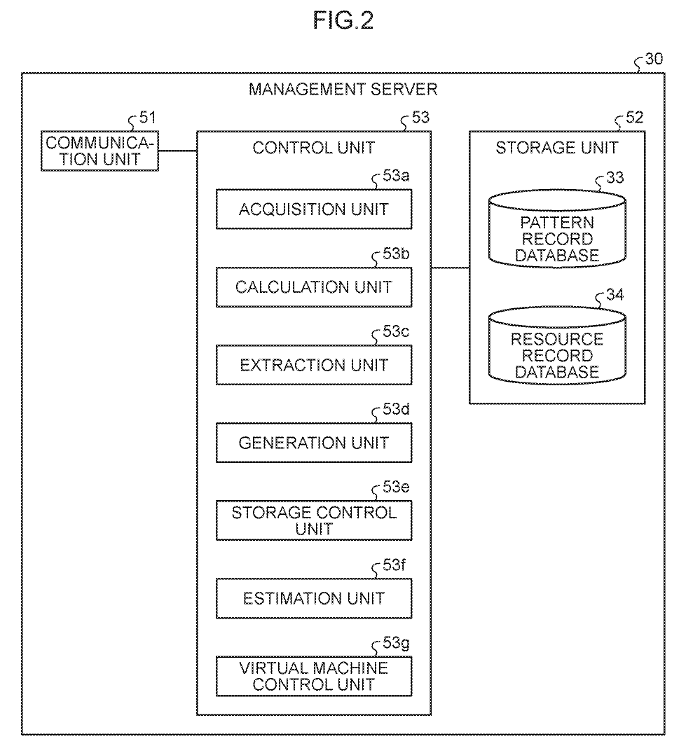

Next, a configuration example and a processing example of the management server 30 are described. FIG. 2 is a block diagram illustrating the configuration example of the management server 30 according to the embodiment.

The management server 30 includes a communication unit 51, a storage unit 52, and a control unit 53. The management server 30 may include an input unit (for example, a keyboard or a mouse) configured to receive various operations from, for example, an administrator of the management server 30 and a display unit (for example, a liquid crystal display) configured to display various types of information.

The communication unit 51 is realized by, for example, a network interface card (NIC). The communication unit 51 is wired or wirelessly connected to a predetermined communication network and transmits and receives information to and from various devices.

The storage unit 52 is realized by, for example, a semiconductor memory element such as a random access memory (RAM) or a flash memory or a storage device such as a hard disk or an optical disc. The storage unit 52 stores therein various programs executed by the control unit 53 for an operating system (OS), the hypervisor 31, and the virtual appliance 32. For example, the storage unit 52 stores therein a program for executing later-described data storage processing. In addition, the storage unit 52 stores various types of data to be used in the programs executed by the control unit 53. For example, the storage unit 52 stores a pattern record database 33 and a resource record database 34.

The pattern record database 33 is a database in which the pattern information generated by compressed sensing and the index associated with the pattern information are stored. The resource record database 34 is a database in which a collection period of the amount of resource usage, the index, and the first and second averages having been used to generate the pattern information are stored for each of the virtual machines 24. Details of the pattern record database 33 and the resource record database 34 are described later.

The control unit 53 is a controller configured to control the management server 30. The control unit 53 is realized, for example, in such a manner that various programs stored in a storage device inside the control unit 53 are executed using RAM as a work area by a processor such as a CPU or a micro processing unit (MPU). Alternatively, the control unit 53 is realized by an integrated circuit such as an application specific integrated circuit (ASIC) or a field programmable gate array (FPGA).

The control unit 53 includes an acquisition unit 53a, a calculation unit 53b, an extraction unit 53c, a generation unit 53d, a storage control unit 53e, an estimation unit 53f, and a virtual machine control unit 53g. The internal configuration of the control unit 53 is not limited to the configuration illustrated in FIG. 2, but may be another configuration that enables later-described data storage processing.

The acquisition unit 53a acquires various types of data. For example, the acquisition unit 53a acquires data on the amount of resource usage in each of the virtual machines 24 at intervals of the first time period. For example, the communication unit 51 receives operation information on each of the virtual machines 24 from the virtualization management software 26 at intervals of the first time period. The acquisition unit 53a acquires the operation information on each of the virtual machines 24, the operation information having been received by the communication unit 51 at intervals of the first time period. The received operation information includes the amount of resource usage in the virtual machine 24, the amount of resource usage having been measured periodically at predetermined time intervals, and a measurement period of the amount of resource usage. Note that the acquisition unit 53a may perform conversion so that the amount of resource usage is within a predetermined range.

The calculation unit 53b performs various calculations. For example, based on the data acquired by the acquisition unit 53a, the calculation unit 53b calculates the first average obtained by averaging the amount of resource usage for the first time period and the second averages obtained by averaging the amount of resource usage at intervals of a second time period obtained by dividing the first time period into a plurality of segments. For example, for each piece of operation information acquired by the acquisition unit 53a, based on the amount of resource usage included in the operation information, the calculation unit 53b calculates the first average obtained by averaging the amount of resource usage for the first time period and the second average obtained by averaging the amount of resource usage at intervals of the second time period obtained by dividing the first time period into a plurality of segments.

The extraction unit 53c performs various types of extraction. For example, from the data acquired by the acquisition unit 53a, the extraction unit 53c extracts the amount of usage of higher-level resource for the first time period as higher-level data and extracts the amount of usage of lower-level resource for the first time period as lower-level data. For example, for each piece of the operation information acquired by the acquisition unit 53a, from the amount of resource usage included in the operation information, the extraction unit 53c extracts the amount of usage of higher-level resource for the first time period as higher-level data and extracts the amount of usage of lower-level resource for the first time period as lower-level data. For example, the extraction unit 53c extracts the maximum value and the minimum value of the amount of resource usage for the first time period. As higher-level data, the extraction unit 53c extracts the amount of resource usage within a first range from the maximum value of the amount of resource usage for the first time period. Furthermore, as lower-level data, the extraction unit 53c extracts the amount of resource usage within a second range from the minimum value of the amount of resource usage for the first time period. For example, the extraction unit 53c extracts the maximum value of the amount of resource usage and up to two values of the amount of usage of higher-level resource within the first range as higher-level data. Furthermore, the extraction unit 53c extracts the minimum value of the amount of resource usage and up to two values of the amount of usage of lower-level resource within the second range as lower-level data.

A time interval for the periodic measurement of the amount of resource usage, the first time period, and the second time period can be changed. The time interval, the first time period, and the second time period are set by, for example, the administrator in accordance with a service provided using the virtual machines 24 by the system 10. For example, for a service involving great variations in the amount of resource usage, a shorter time interval is set. The first time period is set so as not to cause transmission and reception of the operation information to become loads on the virtual machines 24 and the network N. The amount of resource usage to be measured by the hypervisor 25 in each of the management target nodes 20 can also be changed. For example, the amount of resource usage to be measured by the hypervisor 25 can be changed to any of a CPU usage rate, the amount of memory usage, and the amount of storage usage. The amount of resource usage to be measured by the hypervisor 25 is set by, for example, the administrator in accordance with the service provided using the virtual machines 24 by the system 10. Both the first range and the second range can be changed. The first range and the second range are set by, for example, the administrator in accordance with the service provided using the virtual machines 24 by the system 10.

A specific example is described below. For example, the time interval for measuring the amount of resource usage is set to 20 seconds. The first time period is set to 20 minutes. The second time period is set to 5 minutes. The amount of resource usage to be measured by the hypervisor 25 is set as a CPU usage rate. The first range is set at a range of ±10% from the maximum value of the amount of resource usage. The second range is set at a range of ±10% from the minimum value of the amount of resource usage.

In this case, the hypervisor 25 in each of the management target nodes 20 measures the CPU usage rate in each of the virtual machines 24 as the amount of resource usage at time intervals of 20 seconds. For each of the virtual machines 24, the hypervisor 25 transmits the CPU usage rate measured at intervals of 20 seconds and operation information including a measurement period of the CPU usage rate to the virtualization management software 26 of the virtual machine 24a1 at intervals of 20 minutes. The virtualization management software 26 transmits the operation information on each of the virtual machines 24 to the management server 30, the operation information having been received from each of the hypervisors 25.

The communication unit 51 receives the operation information on each of the virtual machines 24 from the virtualization management software 26 at intervals of 20 minutes. The acquisition unit 53a acquires the operation information on each of the virtual machines 24, the operation information having been received by the communication unit 51.

For each piece of the operation information acquired by the acquisition unit 53a, the calculation unit 53b calculates the first average obtained by averaging the CPU usage rates for 20 minutes and the second averages obtained by averaging the CPU usage rates at intervals of 5 minutes obtained by dividing 20 minutes into four segments, based on the amount of resource usage included in the operation information.

For each piece of the operation information acquired by the acquisition unit 53a, the extraction unit 53c extracts the higher-level CPU usage rate for 20 minutes as higher-level data and the lower-level CPU usage rate for 20 minutes as lower-level data from the amount of resource usage included in the operation information.

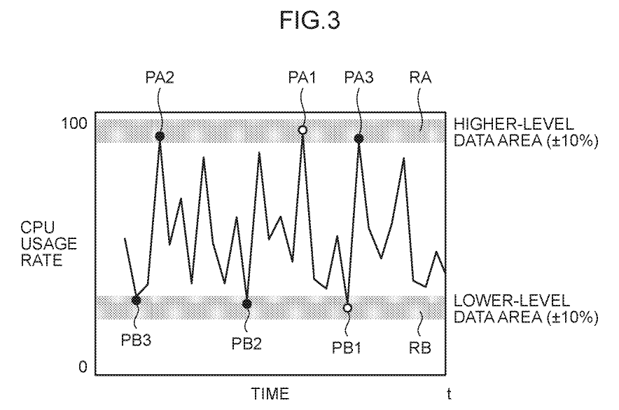

FIG. 3 is a diagram to explain an example of extraction of higher-level data and lower-level data according to the embodiment. In FIG. 3, an example of variations in the CPU usage rate for 20 minutes is illustrated. The extraction unit 53c extracts the maximum CPU usage rate PA1 and the minimum CPU usage rate PB1 for 20 minutes. The extraction unit 53c specifies a range RA of ±10% from the maximum CPU usage rate PA1 for 20 minutes and a range RB of ±10% from the minimum CPU usage rate PB1 for 20 minutes. The extraction unit 53c extracts the maximum CPU usage rate PA1 and up to two higher-level CPU usage rates within the range RA as higher-level data. Furthermore, the extraction unit 53c extracts the minimum CPU usage rate PB1 and up to two lower-level CPU usage rates within the range RB as lower-level data. In the example illustrated in FIG. 3, the maximum CPU usage rate PA1 and the CPU usage rates PA2 and PA3 within the range RA are extracted as higher-level data. The minimum CPU usage rate PB1 and the CPU usage rates PB2 and PB3 within the range RB are extracted as lower-level data.

The maximum CPU usage rate PA1 and up to two higher-level CPU usage rates within the range RA are extracted as higher-level data. Hence, the higher-level data includes one to three higher-level CPU usage rates for 20 minutes. Furthermore, the minimum CPU usage rate PB1 and up to two lower-level CPU usage rates within the range RB are extracted as lower-level data. Hence, the lower-level data includes one to three lower-level CPU usage rates for 20 minutes.

The description returns to FIG. 2. The generation unit 53d generates various types of data. For example, for each piece of the operation information acquired by the acquisition unit 53a, the generation unit 53d patterns the amount of resource usage included in the operation information by using the compressed sensing technology to generate pattern information.

Here, in the estimation of the amount of resource usage, it is important to see average variations in the amount of usage and also how the higher-level and lower-level values of the amount of usage, such as the maximum value and the minimum value of the amount of usage, vary. In the estimation of the amount of resource usage, when about one to three of the amounts of usage of higher-level and lower-level resources are used, the amount of resource usage can be estimated with high accuracy, and, even when three or more of the amounts of usage of higher-level and lower-level resources are used, estimation accuracy remains about the same.

To perform compressed sensing for the operation the higher-level data for 20 minutes, and the lower-level data for 20 minutes. In this case, a 4-by-60 matrix is generated as pattern information.

information, the first and second averages are used as sparse parameters in the compressed sensing, and the extracted higher-level and lower-level data are used as values to be recovered from sparse data. Using the first average and the second averages calculated by the calculation unit 53b and the higher-level data and the lower-level data extracted by the extraction unit 53c as parameters, the generation unit 53d performs compressed sensing for data on the amount of resource usage included in the operation information acquired by the acquisition unit 53a, thereby generating pattern information. For each operation information acquired by the acquisition unit 53a, the generation unit 53d performs compressed sensing for the data on the amount of resource usage included in the operation information, thereby generating pattern information. For example, as described above, when the time interval for measuring the CPU usage rate is 20 seconds and the first time period is 20 minutes, the operation information includes 60 pieces of CPU usage rates for 20 minutes. For example, the generation unit 53d performs compressed sensing using, as parameters, the first average obtained by averaging the CPU usage rates for 20 minutes, the CPU usage rates being included in the operation information, the four second averages obtained by averaging the CPU usage rates at intervals of 5 minutes,

The storage control unit 53e exerts control over the storage of various types of data. The storage control unit 53e exerts control over the storage of the pattern information generated by the generation unit 53d in the storage unit 52. For example, using the second averages calculated by the calculation unit 53b, the storage control unit 53e recovers the higher-level data and the lower-level data from the pattern information stored in the pattern record database 33 of the storage unit 52. The storage control unit 53e determines whether the higher-level data and the lower-level data extracted by the extraction unit 53c match any of the higher-level data and the lower-level data recovered from the stored pattern information.

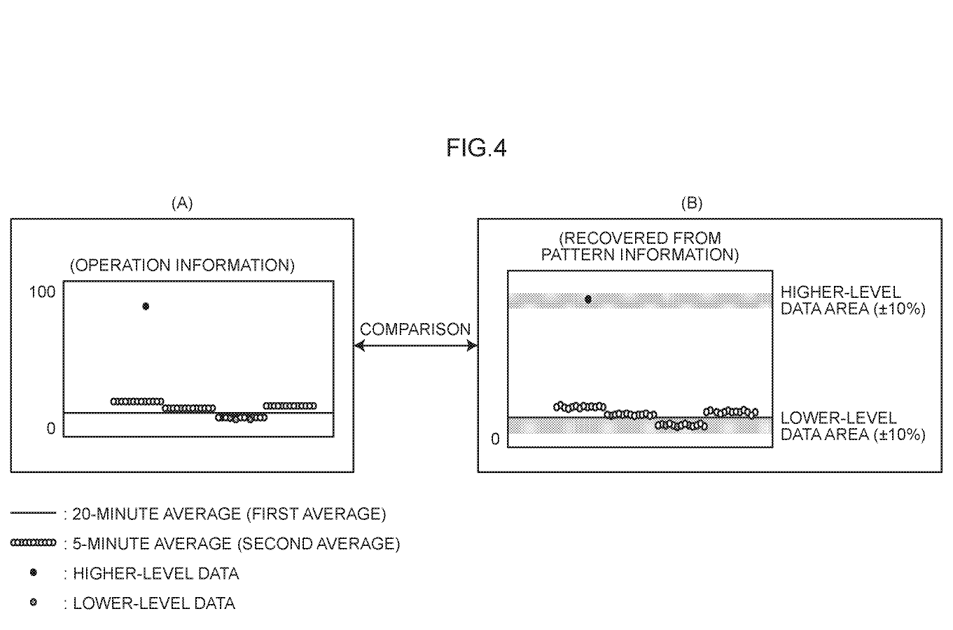

FIG. 4 is a diagram to explain an example of matching determination of the higher-level and lower-level data according to the embodiment. In FIG. 4, there are illustrated the higher-level data and the lower-level data on CPU usage rate for 20 minutes that are included in the operation information, the first average obtained by averaging the CPU usage rates for 20 minutes, and the four second averages obtained by averaging the CPU usage rates at intervals of 5 minutes. In FIG. 4, there are illustrated the higher-level and lower-level data recovered from the stored pattern information, and the first average, and the four second averages. In FIG. 4, the higher-level data, the lower-level data, the first average, and the four second averages are illustrated on a time-series basis, but the higher-level data, the lower-level data, the first average, and the four second averages are numerical values not including time-series information.

The storage control unit 53e determines whether the higher-level and lower-level data on CPU usage rate for 20 minutes that are extracted from the amount of resource usage included in the operation information illustrated in FIG. 4 match the higher-level and lower-level data recovered from the stored pattern information illustrated in FIG. 4.

When the result of the determination reveals that the extracted higher-level and lower-level data do not match any of the recovered higher-level and lower-level data, the storage control unit 53e associates the pattern information generated by the generation unit 53d with a unique index and stores the pattern information in the pattern record database 33 of the storage unit 52. Furthermore, the storage control unit 53e associates a measurement period of the amount of resource usage in the generated pattern information, the index associated with the pattern information, and the first average and the second averages calculated by the calculation unit 53b with each other and stores the measurement period, the index, the first average, and the second averages in the resource record database 34 of the storage unit 52.

On the other hand, when the result of the determination reveals that the extracted higher-level and lower-level data match any of the recovered higher-level and lower-level data, the storage control unit 53e does not store the pattern information in the pattern record database 33 to avoid duplicate storage of similar pattern information. The storage control unit 53e associates the measurement period of the amount of resource usage in the generated pattern information, the index of the stored and matching pattern information, and the first average and the second averages calculated by the calculation unit 53b with each other and stores the measurement period, the index, the first average, and the second averages in the resource record database 34 of the storage unit 52.

### Here, an example of the size of a storage area for storing the amount of resource usage is described.

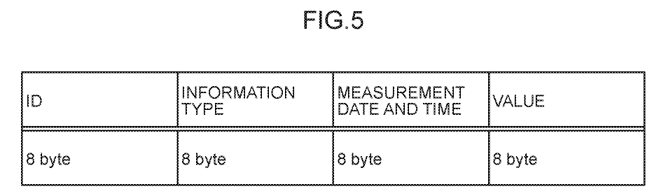

First, as a comparative example, the size of a storage area for storing CPU usage rates measured at intervals of 20 seconds as they are is described. FIG. 5 is a diagram to explain an example of a data structure according to the comparative example. In FIG. 5, there is illustrated an example of a table for storing CPU usage rates collected at intervals of 20 seconds in a database. The table illustrated in FIG. 5 includes the following items: ID, an information type, a measurement date and time, and a value. The ID is an area to store identification (ID) for identifying the virtual machine 24. The information type is an area to store the type of the measured amount of resource usage. The measurement date and time is an area to store a date and time of the measurement of the amount of resource usage. The value is an area to store a value of the measured amount of resource usage. When each of the items, that is, the ID, the information type, the measurement date and time, and the value is an area of 8 bytes, the volume of one record is 32 bytes. When one record is recorded at intervals of 20 seconds, the number of records for one day is 60 × 60 × 24/20 = 4320. The volume of records for one day is 32 bytes × 4320 = 138240 bytes. For example, when one year's amount of resource usage of 1000 pieces of the virtual machines 24 is stored, a storage area of approximately 50 GB is needed.

Next, the size of a storage area for storing the CPU usage rate in the present embodiment is described. Note that, in an example described below, the amount of resource usage is a CPU usage rate (0% to 100%), the CPU usage rate is converted to be a value within a range of -2.0 to +2.0, and the converted value is rounded to one decimal place and the resulting value obtained in 0.1 increments is used to perform compressed sensing.

In the present embodiment, the amount of data on pattern information to be stored in the pattern record database 33 is described. For example, as illustrated in FIG. 3, when the higher-level and lower-level data are extracted, the higher-level data includes one to three higher-level CPU usage rates for 20 minutes. The lower-level data includes the bottom one to three CPU usage rates for 20 minutes.

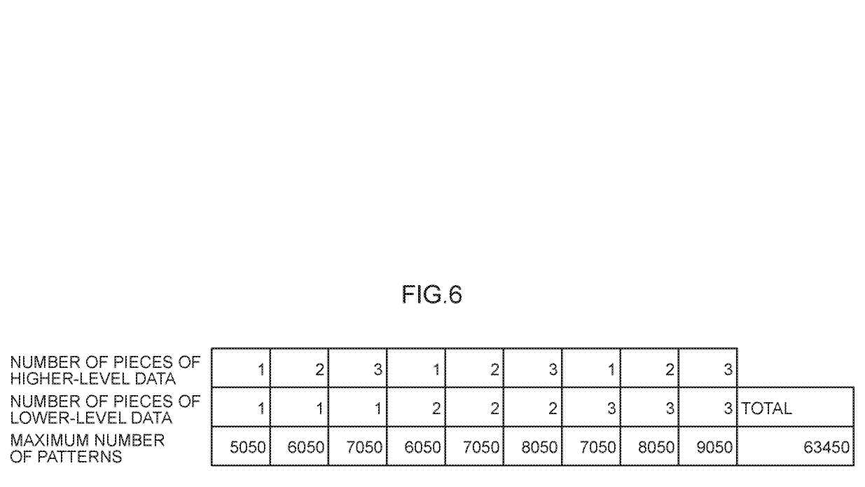

FIG. 6 is a diagram to explain an example of the number of possible patterns of CPU usage rate as the higher-level data and the higher-level data according to the embodiment. Using the CPU usage rates in a range of -2.0 to +2.0, the extraction unit 53c extracts the higher-level data from a range of -10% from the maximum value and extracts the lower-level data from a range of +10% from the minimum value. In this case, for every combination of the number of CPU usage rates extracted as the higher-level data and the number of CPU usage rates extracted as the lower-level data, the maximum number of possible patterns of the CPU usage rate as the higher-level data and the lower-level data is obtained as illustrated in FIG. 6. When the higher-level data and the lower-level data each include up to three CPU usage rates, the theoretical maximum number of patterns is 63450 patterns.

For example, when the pattern information is a 4-by-60 matrix, the volume of one piece of pattern information is: float value (8 bytes) × matrix (4 by 60) = 1920 bytes.

The theoretical maximum number of pattern information is approximately 64000 as described above. Hence, the maximum storage area for storing the pattern information is 1920 bytes × 64000 ≈approximately 122 MB.

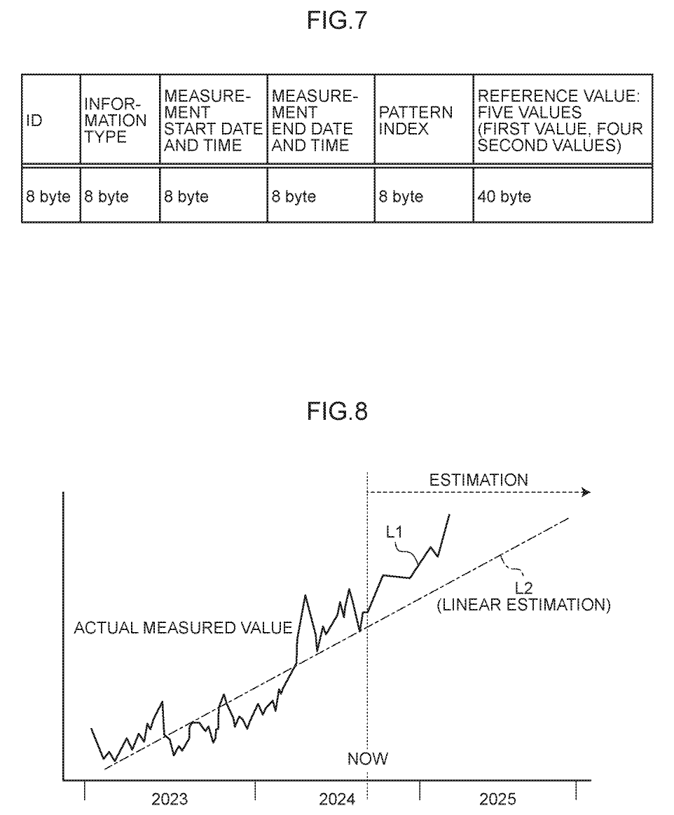

Next, the amount of data to be stored in the resource record database 34 in the present embodiment is described. FIG. 7 is a diagram to explain an example of a data structure according to the embodiment. In FIG. 7, an example of a table of the resource record database 34 is illustrated. The table illustrated in FIG. 7 includes the following items: ID, an information type, a measurement start date and time, a measurement end date and time, a pattern index, and reference values. The ID is an area to store ID for identifying the virtual machine 24. The information type is an area to store the type of the measured amount of resource usage. The measurement start date and time is an area to store a measurement start date and time at which the measurement of the amount of resource usage is started. The measurement end date and time is an area to store a measurement end date and time at which the measurement of the amount of resource usage is ended. The pattern index is an area to store an index associated with pattern information. The reference values are areas to store the first average and the four second averages, respectively. When each of the items, that is, the ID, the information type, the measurement start date and time, the measurement end date and time, and the pattern index is an area of 8 bytes and each of the reference values is an area of 40 bytes, the volume of one record is 80 bytes. When one record is recorded at intervals of 20 minutes, the number of records for one day is 60 × 24/20 = 72. The volume of records for one day is 80 bytes × 72 = 5760 bytes. For example, when one year's records of 1000 pieces of virtual machines 24 are stored, a storage area of approximately 2.2 GB is needed.

When the management server 30 according to the present embodiment stores the one year's amount of resource usage of 1000 pieces of the virtual machines 24, the maximum storage area for storing the amount of resource usage is approximately 2.2 GB + 122 MB in the resource record database 34 and the pattern record database 33. Thus, the management server 30 can reduce the storage area for storing the amount of resource usage to approximately 5% of a capacity (approximately 50 GB) needed in the comparative example.

Thus, the management server 30 according to the present embodiment can store the measured amount of resource usage in a smaller storage area even when the interval between the measurements of the amount of resource usage is shorter.

The estimation unit 53f performs various types of estimation. For example, the estimation unit 53f estimates the amount of resource usage in each of the virtual machines 24 at a predetermined timing. The predetermined timing may be a timing at which the management terminal 40 gives an instruction to estimate the amount of resource usage or may be a fixed timing such as a weekly or monthly basis. For each of the virtual machines 24, the estimation unit 53f reads the index, the first average, and the second averages from the resource record database 34 in order of the measurement periods. For example, for each of the virtual machines 24, the estimation unit 53f reads the index, the first average, and the second averages from the resource record database 34 in order of the measurement start dates and time or the measurement end dates and time. From the pattern record database 33, the estimation unit 53f reads pattern information corresponding to the read index. Using the second averages read together with the index, the estimation unit 53f recovers pattern information corresponding to the index. Thus, for each of the virtual machines 24, the higher-level and lower-level data are recovered from the pattern information in order of the measurement periods. For each of the virtual machines 24, the estimation unit 53f estimates the amount of usage of resources to be used in the future, based on the higher-level and lower-level data recovered in order of the measurement periods, the first average, and the second averages.

FIG. 8 is a diagram to explain an example of estimation results according to the embodiment. In FIG. 8, an estimation result of the amount of resource usage that is estimated by the estimation unit 53f is indicated by a line L1. Furthermore, in FIG. 8, an estimation result of linear estimation performed by linear regression from the average of the one day's amount of resource usage is indicated by a line L2.

The linear estimation is rough estimation of the amount of resource usage and therefore minor variations in the one day's amount of resource use is not able to be estimated.

In contrast, in the present embodiment, the measurement interval of the amount of resource usage can be made shorter, and thus the estimation unit 53f can estimate variations in the amount of resource usage with high accuracy. Furthermore, the estimation unit 53f estimates the amount of resource usage by using the past higher-level and lower-level data in order of the measurement periods and therefore can estimate variations in the maximum value and the minimum value of the amount of resource usage with high accuracy.

The virtual machine control unit 53g controls each of the virtual machines 24. For example, when the result of estimation performed by the estimation unit 53f reveals that a higher load on a particular virtual machine 24 or another reason causes an imbalance in loads on the management target nodes 20, the virtual machine control unit 53g reallocates the virtual machines 24 so that loads on the management target nodes 20 are balanced.

Thus, the management server 30 according to the present embodiment can substantially prevent an imbalance in loads on the management target nodes 20.

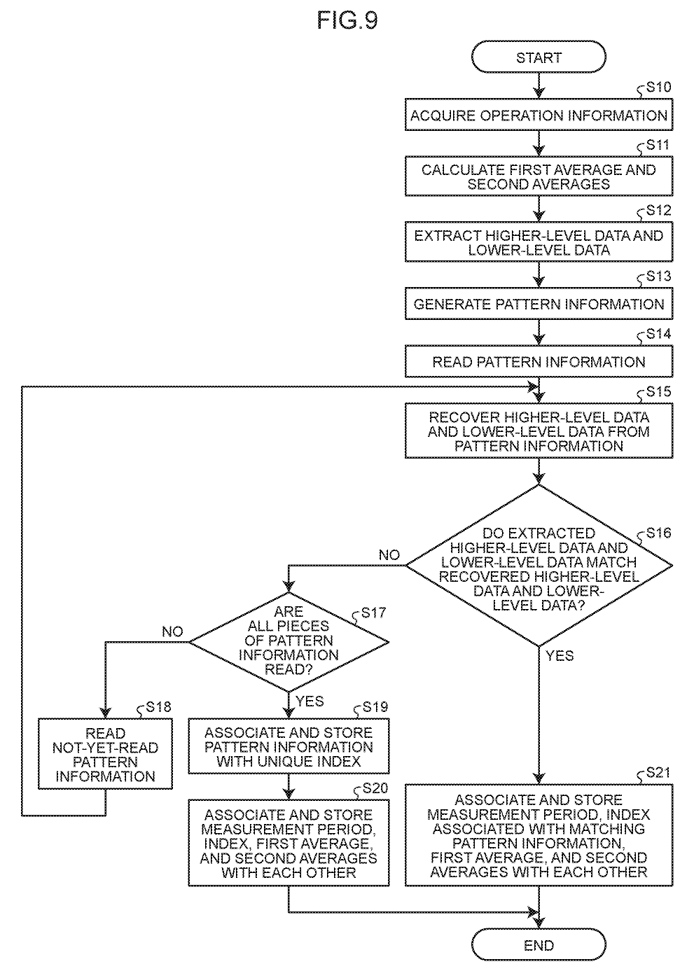

Next, an example of the processing procedure of data storage processing according to the present embodiment is described. FIG. 9 is a flowchart illustrating the processing procedure of data storage processing according to the present embodiment. The processing illustrated in FIG. 9 is executed when the communication unit 51 receives operation information.

The acquisition unit 53a acquires the operation information received by the communication unit 51 (step S10).

Based on the amount of resource usage included in the acquired operation information, the calculation unit 53b calculates the first average obtained by averaging the amount of resource usage for the first time period and the second averages obtained by averaging the amount of resource usage at intervals of the second time period obtained by dividing the first time period into a plurality of segments (step S11).

From the amount of resource usage included in the acquired operation information, the extraction unit 53c extracts the amount of usage of higher-level resource for the first time period as higher-level data and extracts the amount of usage of lower-level resource for the first time period as lower-level data (step S12).

Using the calculated first average and second averages and the extracted higher-level and lower-level data as parameters, the generation unit 53d performs compressed sensing for data on the amount of resource usage included in the acquired operation information, thereby generating pattern information (step S13).

The storage control unit 53e reads the stored pattern information from the pattern record database 33 of the storage unit 52 (step S14).

Using the calculated second averages, the storage control unit 53e recovers the higher-level and lower-level data from the read pattern information (step S15). The storage control unit 53e determines whether the extracted higher-level and lower-level data match the recovered higher-level and lower-level data (step S16).

If the extracted higher-level and lower-level data do not match the recovered higher-level and lower-level data (No at step S16), the storage control unit 53e determines whether all pieces of the pattern information stored in the pattern record database 33 has been read (step S17). If not all the pattern information has been read (No at step S17), the storage control unit 53e reads the not-yet-read pattern information from the pattern record database 33 (step S18) and the processing moves to step S15.

In contrast, if all the pattern information has been read (Yes at step S17), the storage control unit 53e associates the generated pattern information with a unique index and stores the pattern information in the pattern record database 33 (step S19). The storage control unit 53e associates a measurement period of the amount of resource usage in the generated pattern information, the index associated with the pattern information, and the calculated first average and second averages with each other and stores the measurement period, the index, the first average, and the second averages in the resource record database 34 (step S20), and the processing is terminated.

In contrast, if the extracted higher-level and lower-level data match the recovered higher-level and lower-level data (Yes at step S16), the storage control unit 53e associates the measurement period of the amount of resource usage in the generated pattern information, the index of the stored and matching pattern information, and the calculated first average and second averages with each other and stores the measurement period, the index, the first average, and the second averages in the resource record database 34 (step S21), and the processing is terminated.

Note that the embodiment above is described using an example in which all pieces of the pattern information stored in the pattern record database 33 is read to determine the matching of the higher-level and lower-level data. However, the present embodiment is not limited to the example. Each combination of the number of the amount of resource usage as the higher-level data and the number of the amount of resource usage as the lower-level data may be given to a corresponding one of index ranges, and pattern information may be associated with indexes in ranges corresponding to the number of the amount of resource usage as the higher-level data and the number of the amount of resource usage as the lower-level data, and stored in the pattern record database 33. The storage control unit 53e may sequentially read, from the pattern record database 33, the pattern information associated with the index in the range corresponding to a combination of the number of the amount of resource usage as the extracted higher-level data and the number of the amount of resource usage as the extracted lower-level data, and may determine the matching of the higher-level and lower-level data. In this case, the number of the pattern information read from the pattern record database 33 can be reduced, and thus loads on the processing of determining the matching of the higher-level and lower-level data can be reduced.

Furthermore, the embodiment above is described using an example in which the amount of resource usage measured using the pattern record database 33 and the resource record database 34 is stored. However, in the present embodiment, the measured amount of resource usage may be stored by storing the generated pattern information in the storage unit 52 in order of the measurement periods. Even in this case, the measured amount of resource usage can be stored in a smaller storage area.

Next, the effect of the management server 30 according to the present embodiment is described. Based on the amount of resource usage included in the operation information, the management server 30 calculates the first average obtained by averaging the amount of resource usage for the first time period and the second averages obtained by averaging the amount of resource usage at intervals of the second time period obtained by dividing the first time period into a plurality of segments. Furthermore, the management server 30 extracts the amount of usage of higher-level resource for the first time period as the higher-level data from the amount of resource usage included in the operation information. Using the calculated first average and second averages and the extracted higher-level and lower-level data as parameters, the management server 30 performs compressed sensing for the amount of resource usage included in the operation information to generate pattern information. The management server 30 stores the generated pattern information in the pattern record database 33 of the storage unit 52. Thus, by storing the pattern information obtained by performing compressed sensing for the amount of resource usage in the storage unit 52, the management server 30 can store the measured amount of resource usage in a smaller storage area.

The management server 30 uses the calculated second averages to recover the higher-level and lower-level data from the pattern information stored in the pattern record database 33 of the storage unit 52. When the extracted higher-level and lower-level data do not match any of the higher-level and lower-level data recovered from the stored pattern information, the management server 30 associates the generated pattern information with a unique index and stores the pattern information in the pattern record database 33 of the storage unit 52. Thus, the management server 30 can substantially prevent duplicate storage of pattern information including similar higher-level and lower-level data to be recovered, and can thereby achieve as a smaller storage area for storing pattern information.

When the extracted higher-level and lower-level data do not match any of the higher-level and lower-level data recovered from the stored pattern information, the management server 30 associates a measurement period of the amount of resource usage in the generated pattern information, the index associated with the pattern information, the calculated first average and second averages with each other and stores the measurement period, the index, the first average, and the second averages in the resource record database 34 of the storage unit 52. When the extracted higher-level and lower-level data match any of the recovered higher-level and lower-level data, the management server 30 associates the measurement period of the amount of resource usage, the index associated with the stored and matching pattern information, and the calculated first average and second averages with each other and stores the measurement period, the index, the first average, and the second averages in the resource record database 34 of the storage unit 52. Thus, the management server 30 can store the measured amount of resource usage in a smaller storage area.

The management server 30 extracts the maximum and minimum values of the amount of resource usage for the first time period, and extracts, as higher-level data, the amount of resource usage within the first range from the maximum value, and extracts, as lower-level data, the amount of resource usage within the second range from the minimum value. Thus, the management server 30 can extract the higher-level and lower-level data in a range close to the maximum and minimum values.

The management server 30 extracts the maximum value of the amount of resource usage and up to two values of the amount of usage of higher-level resource within the first range as higher-level data, and extracts the minimum value of the amount of resource usage and up to two values of the lower amount of resource usage within the second range as lower-level data. In the estimation of the amount of resource usage, when about one to three of the amounts of usage of higher-level and lower-level resources are used, the amount of resource usage can be estimated with high accuracy, and, even when three or more of the amounts of usage of higher-level and lower-level resources are used, estimation accuracy remains about the same. The management server 30 can estimate the amount of resource usage with high accuracy by extracting one to three values of the amount of usage of higher-level resource as the higher-level data and one to three of the amount of usage of lower-level resource as the lower-level data.

The first range is ±10% from the maximum value. The second range is ±10% from the minimum value. Thus, the management server 30 can extract the higher-level data from values in a range of ±10% from the maximum value and extract the lower-level data from values in a range of ±10% from the minimum value.

The first time period and the second time period can be changed. Thus, the management server 30 can adjust the first and second time periods in accordance with the type of the amount of resource usage and the degree of variations in the amount of resource usage.

The amount of resource usage is any of a CPU usage rate, an amount of memory usage, and the amount of storage usage. Thus, the management server 30 can store the CPU usage rate, the amount of memory usage, and the amount of storage usage in a smaller storage area even when measurements thereof are performed at shorter intervals.

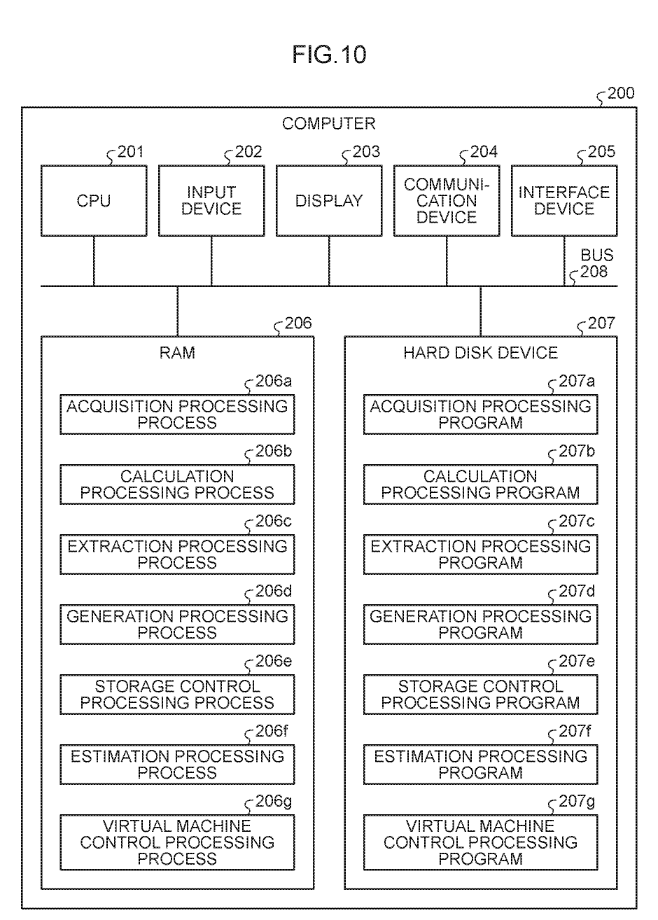

Next, an example of the hardware configuration of a computer that realizes the same functions as those of the management server 30 described above is described. FIG. 10 is a diagram illustrating an example of the hardware configuration of a computer that realizes the same functions as those of the management server 30 according to the embodiment. As illustrated in FIG. 10, a computer 200 includes a CPU 201 configured to perform various types of arithmetic processing, an input device 202 configured to receive data input from the user, and a display 203. The computer 200 further includes a communication device 204 configured to transmit and receive data to and from an external device and other devices via a wired or wireless network, and an interface device 205. The computer 200 further includes a RAM 206 configured to temporarily store therein various types of information and a hard disk device 207. The devices 201 to 207 are connected to a bus 208.

The hard disk device 207 includes an acquisition processing program 207a, a calculation processing program 207b, an extraction processing program 207c, a generation processing program 207d, a storage control processing program 207e, an estimation processing program 207f, and a virtual machine control processing program 207g. The CPU 201 reads the programs 207a to 207g and loads the programs 207a to 207g on the RAM 206.

The acquisition processing program 207a functions as an acquisition processing process 206a. The calculation processing program 207b functions as a calculation processing process 206b. The extraction processing program 207c functions as an extraction processing process 206c. The generation processing program 207d functions as a generation processing process 206d. The storage control processing program 207e functions as a storage control processing process 206e. The estimation processing program 207f functions as an estimation processing process 206f. The virtual machine control processing program 207g functions as a virtual machine control processing process 206g.

The processing of the acquisition processing process 206a corresponds to the processing performed by the acquisition unit 53a. The processing of the calculation processing process 206b corresponds to the processing performed by the calculation unit 53b. The processing of the extraction processing process 206c corresponds to the processing performed by the acquisition unit 53a. The processing of the generation processing process 206d corresponds to the processing performed by the generation unit 53d. The processing of the storage control processing process 206e corresponds to the processing performed by the storage control unit 53e. The processing of the estimation processing process 206f corresponds to the processing performed by the estimation unit 53f. The processing of the virtual machine control processing process 206g corresponds to the processing performed by the virtual machine control unit 53g.

Note that the programs 207a to 207g are not necessarily stored in the hard disk device 207 from the beginning. For example, each of the programs is stored on a "portable physical medium" to be inserted into the computer 200, such as a flexible disk (FD), CD-ROM, DVD, a magneto-optical disc, or IC card. The computer 200 may read and execute the programs 207a to 207g.

Thus, the measured amount of resource usage can be stored in a smaller storage area.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. An information processing apparatus comprising:
a processor configured to:
acquire data on an amount of resource usage of a virtual machine at intervals of a first time period, the amount of resource usage being measured periodically for the first time period;
based on the data acquired, calculate a first average obtained by averaging the amount of resource usage for the first time period and a second average obtained by averaging the amount of resource usage at intervals of a second time period obtained by dividing the first time period into a plurality of segments;
extract an amount of usage of higher-level resource for the first time period as higher-level data and extract an amount of usage of lower-level resource for the first time period as lower-level data from the data acquired;
by using the first average and a plurality of the second averages calculated and the higher-level data and the lower-level data extracted as parameters, perform compressed sensing for the data acquired to generate pattern information; and
exert control over storage of the pattern information generated in a storage.

2. The information processing apparatus according to claim 1, wherein, using the second averages calculated, the processor is further configured to recover the higher-level data and the lower-level data from the pattern information stored in the storage, and, when the higher-level data and the lower-level data extracted do not match any of the higher-level data and the lower-level data recovered from the pattern information stored in the storage, associate the pattern information generated with a unique identifier and stores the pattern information in the storage.

3. The information processing apparatus according to claim 2, wherein,
when the higher-level data and the lower-level data extracted do not match any of the higher-level data and the lower-level data recovered from the pattern information stored, the processor is further configured to store a measurement period of the amount of resource usage in the pattern information generated, the identifier associated with the pattern information, and the first average and the second averages calculated, with each other, and store the measurement period, the identifier, the first average, and the second averages in the storage, and
when the higher-level data and the lower-level data extracted match any of the higher-level data and the lower-level data recovered from the pattern information stored, the processor is further configured to associate the measurement period, the identifier associated with the pattern information stored and matching, and the first average and the second averages calculated, with each other, and store the measurement period, the identifier, the first average, and the second averages in the storage.

4. The information processing apparatus according to claim 1, wherein the processor is further configured to extract a maximum value and a minimum value of the amount of resource usage for the first time period, and extract the amount of resource usage within a first range from the maximum value as higher-level data and extract the amount of resource usage within a second range from the minimum value as lower-level data.

5. The information processing apparatus according to claim 4, wherein the processor is further configured to extract the maximum value of the amount of resource usage and up to two values of the amount of usage of higher-level resource within the first range as higher-level data, and extract the minimum value of the amount of resource usage and up to two values of the amount of usage of lower-level resource within the second range as lower-level data.

6. The information processing apparatus according to claim 5, wherein
the first range is a range of ±10% from the maximum value, and
the second range is a range of ±10% from the minimum value.

7. The information processing apparatus according to claim 1, wherein the first time period and the second time period are allowed to be changed.

8. The information processing apparatus according to claim 1, wherein the amount of resource usage is any of a CPU usage rate, an amount of memory usage, and an amount of storage usage.

9. A data storage method comprising:
acquiring data on an amount of resource usage of a virtual machine at intervals of a first time period, the amount of resource usage being measured periodically for the first time period;
based on the data acquired, calculating a first average obtained by averaging the amount of resource usage for the first time period and a second average obtained by averaging the amount of resource usage at intervals of a second time period obtained by dividing the first time period into a plurality of segments;
from the data acquired, extracting an amount of usage of higher-level resource for the first time period as higher-level data and extracting an amount of usage of lower-level resource for the first time period as lower-level data;
by using the first average and a plurality of the second averages calculated and the higher-level data and the lower-level data extracted as parameters, performing compressed sensing for the data acquired to generate pattern information; and
exerting control over storage, in a storage, of the pattern information generated, by a processor.

10. A non-transitory computer-readable recording medium storing therein a data storage program that causes a computer to execute a process comprising:
acquiring data on an amount of resource usage of a virtual machine at intervals of a first time period, the amount of resource usage being measured periodically for the first time period;
based on the data acquired, calculating a first average obtained by averaging the amount of resource usage for the first time period and a second average obtained by averaging the amount of resource usage at intervals of a second time period obtained by dividing the first time period into a plurality of segments;
from the data acquired, extracting an amount of usage of higher-level resource for the first time period as higher-level data and extracting an amount of usage of lower-level resource for the first time period as lower-level data;
by using the first average and a plurality of the second averages calculated and the higher-level data and the lower-level data extracted as parameters, performing compressed sensing for the data acquired to generate pattern information; and
exerting control over storage, in a storage, of the pattern information generated.
